(19) United States
(12) Patent Application Publication
(10) Pub. No.: US 2020/0061909 A1
(43) Pub. Date: Feb. 27, 2020

(54) THREE DIMENSIONAL PRINTING METHOD AND THREE DIMENSIONAL PRINTING APPARATUS

(71) Applicants: XYZprinting, Inc., New Taipei City (TW); Kinpo Electronics, Inc., New Taipei City (TW)

(72) Inventor: Shau-An Tsai, New Taipei City (TW)

(73) Assignees: XYZprinting, Inc., New Taipei City (TW); Kinpo Electronics, Inc., New Taipei City (TW)

(21) Appl. No.: 16/214,117

(22) Filed: Dec. 9, 2018

(30) Foreign Application Priority Data
Aug. 24, 2018 (TW) 107129566

(51) Int. Cl. B29C 64/20; B29C 64/112; B29C 64/386; B29C 64/40

(52) U.S. Cl. CPC B29C 64/20; B29C 64/40; B29C 64/386; B29C 64/112

(57) ABSTRACT

A three dimensional printing method and a three dimensional printing apparatus are provided. The three dimensional printing method includes: acquiring a first contour pattern and a first support point corresponding to an Nth sliced object according to a plurality of slice information of the sliced objects of a 3D model, and acquiring a second contour pattern and a plurality of reference points of an (N+1)th sliced object; determining second positions of second support points of the (N+1)th sliced object according to the first contour pattern, a supportable range of the first support point, the second contour pattern, and the reference points; and printing a support element on a platform according to the first position and the second position.

### CROSS-REFERENCE TO RELATED APPLICATION

This application claims the priority benefit of Taiwan application no. 107129566, filed on Aug. 24, 2018. The entirety of the above-mentioned patent application is hereby incorporated by reference herein and made a part of this specification.

### BACKGROUND OF THE INVENTION

### 1. Field of the Invention

The invention relates to a three dimensional printing method and a three dimensional printing apparatus.

### 2. Description of Related Art

With advances in computer-aided manufacturing (CAM), the manufacturing industry has developed the three dimensional (3D) printing technology, which is capable of rapidly fabricating products from an original design concept. The three dimensional printing technology is in fact a collective term for a series of rapid prototyping (RP) techniques with the basic principle of laminate manufacturing, where a rapid prototyping machine forms cross-sectional shapes of a workpiece in the X-Y plane by ways of scanning, shift intermittently at a layer thickness in the Z coordinates so a 3D object can be eventually formed. The three dimensional printing technology is applicable regardless of the geometric shapes and the RP technology produces excellent outputs in particular for complex parts, which saves efforts and processing time significantly.

Because the three dimensional printing technology belongs to a laminate manufacturing technology, if a 3D model includes many protruding portions, suspended portions, which are apparent and not supported, would be produced on a platform of the three dimensional printing apparatus. Accordingly, when the suspended portions are being printed, the suspended portions may collapse and cause a printing failure.

### SUMMARY OF THE INVENTION

The invention provides a three dimensional printing method and a three dimensional printing apparatus that can be used to print the 3D model having the suspended portions.

The three dimensional printing method of the invention is used in the three dimensional printing apparatus. The three dimensional printing apparatus is configured to print a 3D model and at least one support element supporting the 3D model on a platform. The at least one support element connects to at least one support point on the 3D model. The three dimensional printing method includes: acquiring a plurality of slice information of a plurality of sliced objects corresponding to the 3D model, wherein a normal vector direction of each sliced object among the plurality of sliced objects is identical to a normal vector direction of the platform, the plurality of sliced objects comprise an Nth sliced object and an (N+1)th sliced object adjacent to the Nth sliced object, and a distance between the Nth sliced object and the platform is less than a distance between the (N+1)th sliced object and the platform, wherein N is a positive integer greater than 0; acquiring a first contour pattern corresponding to the Nth sliced object and a first position of a first support point among the at least one support point located in the Nth sliced object according to first slice information among the plurality of slice information; acquiring a second contour pattern corresponding to the (N+1)th sliced object according to second slice information among the plurality of slice information; determining a plurality of reference points located in the second contour pattern; determining a second position of a second support point among the at least one support point located in the (N+1)th sliced object according to a first region surrounded by the first contour pattern, a first supportable range corresponding to the first support point, a second region surrounded by the second contour pattern and the plurality of reference points; and printing support elements connecting to the first support point and the second support point respectively among the at least one support element on the platform according to the first position and the second position.

The three dimensional printing apparatus of the invention includes a platform, a print head and a processor. The print head is configured to print a 3D model on the platform. The processor is configured to acquire a plurality of slice information of a plurality of sliced objects corresponding to the 3D model. A normal vector direction of each sliced object among the plurality of sliced objects is identical to a normal vector direction of the platform, the plurality of sliced objects comprise an Nth sliced object and an (N+1)th sliced object adjacent to the Nth sliced object, and a distance between the Nth sliced object and the platform is less than a distance between the (N+1)th sliced object and the platform, Here, N is a positive integer greater than 0. The processor acquires a first contour pattern corresponding to the Nth sliced object and a first position of a first support point among the at least one support point located in the Nth sliced object according to first slice information among the plurality of slice information. The processor acquires a second contour pattern corresponding to the (N+1)th sliced object according to second slice information among the plurality of slice information, and determines a plurality of reference points located in the second contour pattern. The processor determines a second position of a second support point among the at least one support point located in the (N+1)th sliced object according to a first region surrounded by the first contour pattern, a first supportable range corresponding to the first support point, a second region surrounded by the second contour pattern and the plurality of reference points. In addition, the processor prints one support elements connecting to the first support point and the second support point respectively among the at least one support element on the platform according to the first position and the second position.

Based on the above, in the invention, the first contour pattern and the first support point corresponding to the Nth sliced object are acquired according to the slice information of the sliced objects of the 3D model, and the second contour pattern and the reference points of the (N+1)th sliced object are also acquired. The second position of the second support points of the (N+1)th sliced object is determined according to the first contour pattern, the supportable range of the first support point, the second contour pattern, and the reference points. Support elements are printed on a platform according to the first position and the second position. As a result, the suspended portions of the 3D model are supported by the support elements, so as to prevent the suspended portions from collapsing.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a three dimensional printing apparatus according to an embodiment of the invention.

FIG. 2 is a flowchart illustrating a three dimensional printing method according to an embodiment of the invention.

FIG. 3 is a schematic diagram illustrating how a contour pattern is generated according to an embodiment of the invention.

FIG. 4A to FIG. 4F are schematic diagrams illustrating how reference points and support points are generated according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

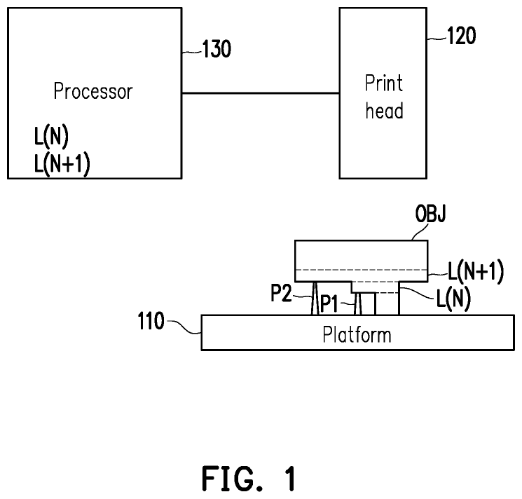

With reference to FIG. 1, FIG. 1 is a schematic diagram illustrating a three dimensional printing apparatus according to an embodiment of the invention. In this embodiment, a three dimensional printing apparatus includes a platform 110, a print head 120 and a processor 130. The print head 120 is configured to form a 3D model OBJ on the platform 110. The processor 130 is configured to acquire a plurality of slice information of a plurality of sliced objects of the 3D model OBJ, acquire a plurality of contour patterns according to the plurality of slice information, and print support elements P1 and P2 according to a plurality of reference points located in the plurality of contour patterns. For instance, the processor 130 can at least acquire Nth slice information LI(N) (first slice information) of an Nth sliced object L(N) and (N+1)th slice information LI(N+1) (second slice information) of an (N+1)th sliced object L(N+1) of the 3D model OBJ. The processor 130 then prints the support elements P1 and P2 according to the Nth slice information LI(N) and the (N+1)th slice information LI(N+1). Here, N is a positive integer greater than 0. The processor 130 of this embodiment is, for example, a central processing unit (CPU) or other programmable devices for general purpose or special purpose such as a microprocessor and a digital signal processor (DSP), a programmable controller, an application specific integrated circuit (ASIC), a programmable logic device (PLD) or other similar devices or a combination of above-mentioned devices, which can load in computer programs for execution.

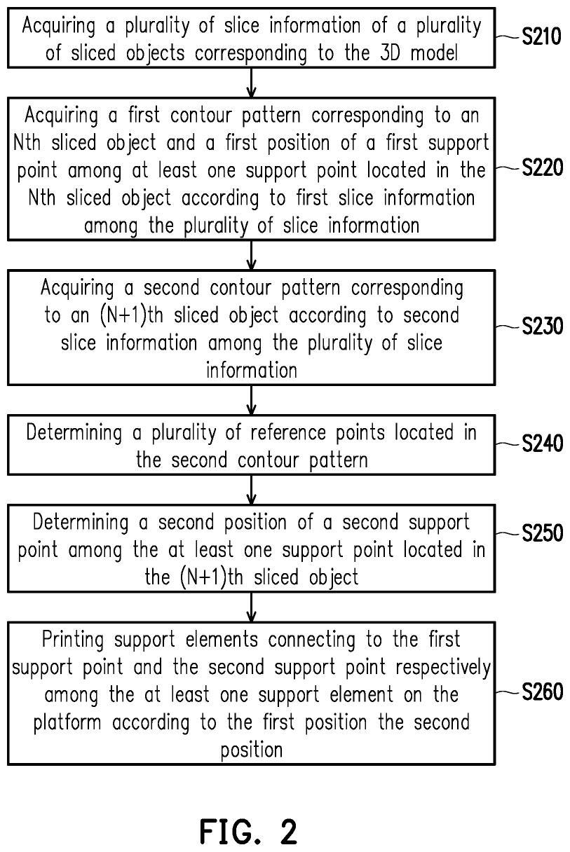

Referring to FIG. 1 and FIG. 2 together, FIG. 2 is a flowchart illustrating a three dimensional printing method according to an embodiment of the invention. In step S210, the processor 130 acquires a plurality of slice information of a plurality of sliced objects corresponding to the 3D model. In step S210, the processor 130 would divide the 3D model OBJ into a plurality of sliced objects and acquire a plurality of slice information corresponding to the plurality of sliced objects. Among the plurality of sliced objects, a normal vector direction of each sliced object is identical to a normal vector direction of the platform 110. In other words, the plurality of sliced objects are parallel to a plane of the platform 110. In this embodiment, the processor 130 can divide the 3D model OBJ at least into an Nth sliced object L(N) and an (N+1)th sliced object L(N+1), and acquire Nth slice information LI(N) corresponding to the Nth sliced object L(N) and (N+1)th slice information LI(N+1) corresponding to the (N+1)th sliced object L(N+1). For the Nth sliced object and the (N+1)th sliced object adjacent to the Nth sliced object, a distance between the Nth sliced object L(N) and the platform 110 is less than a distance between the (N+1)th sliced object L(N+1) and the platform 110. In other words, the Nth sliced object L(N) is closer to the platform 110 than the (N+1)th sliced object L(N+1).

In step S220, the processor 130 acquires a first contour pattern corresponding to the Nth sliced object and a first position of a first support point among at least one support point located in the Nth sliced object according to the Nth slice information LI(N). Then, in step S230, a second contour pattern corresponding to the (N+1)th sliced object is acquired according to second slice information among the plurality of slice information.

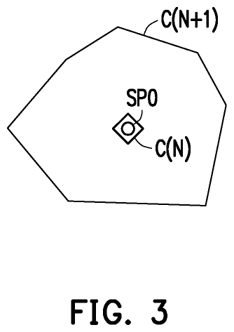

The embodiment for generating the contour pattern is described more specifically below with reference to FIG. 1, FIG. 2 and FIG. 3. FIG. 3 is a schematic diagram illustrating how a contour pattern is generated according to an embodiment of the invention. In this embodiment, the processor 130 makes the Nth sliced object L(N) of the 3D model OBJ capable of generating a section pattern corresponding to the Nth sliced object L(N) in a plane direction of the platform 110 in step S220. A contour of the section pattern of the Nth sliced object L(N) is used as a first contour pattern C(N). Other than that, if the Nth sliced object L(N) is supported by the support point, the processor 130 obtains a position (the first position) of a support point SP0 for supporting the Nth sliced object L(N). In this embodiment, a number of the support points for supporting the Nth sliced object L(N) is merely an example. The number of the support points in the invention may be one or more without particular limitations.

In certain embodiments, if the Nth sliced object L(N) is the first sliced object, that is, the Nth sliced object L(N) does not have the support point, the processor 130 can correspondingly form a plurality of reference points according to the first contour pattern C(N), and determine a position of the support point on the Nth sliced object L(N) according to the reference points located in the first contour pattern C(N).

Referring back to FIG. 1 and FIG. 2, after the first contour pattern, the second contour pattern and the first position of the first support point among the support points of the Nth sliced object are acquired by the processor 130 in steps S220 and S230, the processor 130 determines a plurality of reference points located in the second contour pattern in step S240.

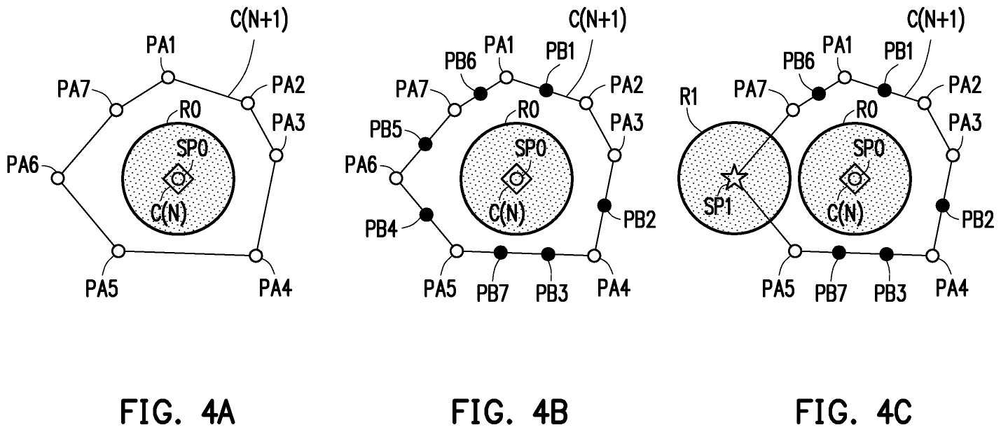

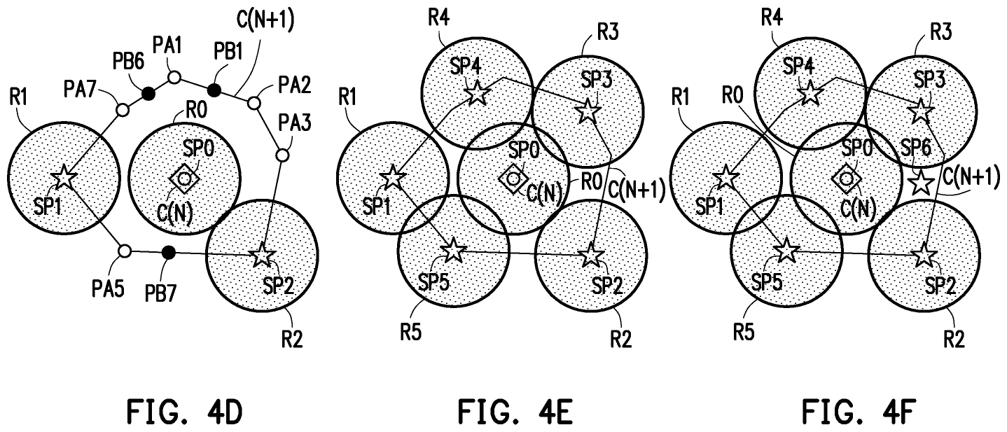

More specifically, FIG. 4A to FIG. 4F are schematic diagrams illustrating how reference points and support points are generated according to an embodiment of the invention. Referring to FIG. 1, FIG. 2 and FIG. 4A, the processor 130 determines reference points PA1 to PA7 according to a plurality of end points of a second contour pattern C(N+1) in step S240. In certain embodiments, the processor 130 can determine the reference points on an edge of the second contour pattern C(N+1) in an equidistant manner. In certain embodiments, the processor 130 can scale down the second contour pattern C(N+1) into an adjusted contour pattern, and determine the reference points according to a plurality of end points of the adjusted contour pattern.

Referring back to FIG. 1 and FIG. 2, after determining the reference points, the processor 130 determines a second position of a second support point among the at least one support point located in the (N+1)th sliced object according to a first region surrounded by the first contour pattern, a first supportable range corresponding to the first support point, a second region surrounded by the second contour pattern and the plurality of reference points in step S250.

More specifically, referring to FIG. 1 and FIG. 4A to FIG. 4F together, in this embodiment, the processor 130 performs a union operation on the first region surrounded the first contour pattern C(N) and a supportable range corresponding to the support point SP0 so as to acquire a union region R0 (a third region). The processor 130 acquires a fourth region by subtracting the union region R0 from the second region surrounded by the second contour pattern C(N+1). Next, the processor 130 determines first reference points among the plurality of reference points according to a plurality of end points of the fourth region. Each of the first reference points is located on one of the end points of the fourth region. In view of FIG. 4A, because the union region R0 does not overlap with the positions of the reference points PA1 to PA7 of the second region, the reference points PA1 to PA7 are the first reference points. For instance, if the union region R0 overlaps with the positions of the reference points PA6 and PA7 of the second region, the reference points PA1 to PA5 are the first reference points. As another example, if the fourth region is equal to the second region (i.e., the (N+1)th sliced object L(N+1) is not supported by the Nth sliced object L(N)), the reference points PA1 to PA7 are the first reference points. As another example, if the fourth region does not exist, it means that the union region R0 completely covers the fourth region or the union region R0 is equal to the fourth region (which also means that the Nth sliced object L(N) can completely support the (N+1)th sliced object L(N+1)), and thus the first reference points are not required.

The processor 130 selects the reference points PA1 to PA7 (the first reference points) one by one to be a second reference point among the first reference points PA1 to PA7 and selects another reference point adjacent to the second reference point to be a third reference point. The processor 130 determines whether a distance (a first distance) between the second reference point and the third reference point is greater than a first preset distance. When processor 130 determines that the distance between the second reference point and the third reference point is greater than the first reset distance, the processor 130 disposes a fourth reference point between the second reference point and the third reference point. The fourth reference point is disposed such that a distance between the second reference point and the fourth reference point is less than the first preset distance and a distance between the third reference point and the fourth reference point. In addition, the processor 130 adds the forth reference point into the plurality of reference points.

Here, it is assumed that, the processor 130 selects the reference point PA1 among the reference points PA1 to PA7 to be the second reference point, and selects the reference point PA2 adjacent to the reference point PA1 to be the third reference point. The processor 130 then determines whether a distance between the reference points PA1 and PA2 is greater than the first preset distance. When processor 130 determines that the distance between the reference points PA1 and PA2 is greater than the first reset distance, the processor 130 disposes a reference point PB1 between the reference points PA1 and PA2. Further, the processor 130 adds the reference point PB1 into the plurality of reference points so that the fourth region includes the reference points PA1 to PA7 and PB1. As another example, the processor 130 selects the reference point PA2 among the reference points PA1 to PA7 to be the second reference point, and selects the reference point PA3 adjacent to the reference point PA2 to be the third reference point. When processor 130 determines that the distance between the reference points PA2 and PA3 is not greater than the first reset distance, the processor 130 does not dispose the reference point between the reference points PA2 and PA3.

In this embodiment, after repeating the above operation, the fourth region would eventually include reference points PA1 to PA7 and PB1 to PB7, as shown by FIG. 4B.

In this embodiment, the first preset distance is associated with a radius of a supportable range of the support element. In other words, the first preset distance may be equal to the radius of the supportable range of the support element. Alternatively, the first preset distance may be, for example, 80%, 50% or 200% of the radius of the supportable range of the support element (i.e., a diameter of the supportable range). The first preset distance may be adjusted based on design requirements. The supportable range of the support element is determined by a structure and a printing material of the support element.

Next, the second support point is to be determined. As shown by FIGS. 4B and 4C, the processor 130 selects, from the reference points PA1 to PA7 and PB1 to PB7, one reference point with a distance (i.e., a second distance) farthest away from the first support point SP0 and greater than the supportable range of the support point to be a fifth reference point. In other words, a distance between the fifth reference point and the first support point SP0 is greater than a distance from each of the other reference points to the first support point SP0, and greater than the supportable range of each support point among the at least one support point.

For instance, among the reference points PA1 to PA7 and PB1 to PB7, because the reference point PA6 has the distance farthest away from the first support point SP0 and greater than the supportable range of the support point, the processor 130 selects the reference point PA6 from the reference points PA1 to PA7 and PB1 to PB7 to be the fifth reference point. The reference point PA6 is the reference point with the distance farthest away from the first support point SP0 among the reference points PA1 to PA7 and PB1 to PB7. Other than that, the distance between the reference point PA6 and the first support point SP0 is greater than a supportable range of the first support point SP0. The processor 130 uses the reference point PA6 as a second support point SP1 and removes the reference point PA6 from the reference points PA1 to PA7 and PB1 to PB7. In other words, as shown in FIG. 4C, after the reference point PA6 is used as the second support point SP1, the fourth region includes the reference points PA1 to PA5, PA7, and PB1 to PB7.

In certain embodiments, the processor 130 would also remove the reference point covered by the supportable range R1 of the second support point SP1. As shown by FIGS. 4B and 4C, because positions of the reference points PB4 and PB5 are located within the range of a supportable range R1, the reference points PB4 and sPBS would be removed after the second support point SP1 is determined. In some other embodiments, the reference points PB4 and the PB5 are removed only after all the second support points are determined.

After the second support point SP1 is determined, the processor 130 selects a sixth reference point from the reference points PA1 to PA5, PA7, PB1 to PB3, PB6 and PB7. The sixth reference point needs to satisfy the following conditions: a distance (a third distance) between the sixth reference point and the first support point SP0 is greater than the supportable range of each support point; a distance (a fourth distance) between the sixth reference point and the second support point SP1 is greater than the supportable range of each support point; and one of the third distance and the fourth distance is greater than a distance from each of the other reference points excluding the sixth reference point to the first support point SP0 and a distance from each of the other reference points excluding the sixth reference point to the second support point SP1. In other words, the selected sixth reference point is outside the supportable ranges of first support point SP0 and the second support point SP1, and said one of the third distance and the fourth distance is a maximum distance between the reference point and the support point among all the reference points and all the support points (the first support point SP0 and the second support point SP1).

Here, for instance, among the reference points PA1 to PA5, PA7, PB1 to PB3, PB6 and PB7, the third distance between the reference point PA4 and the first support point SP0 is greater than the supportable range of each support point, and the fourth distance between the reference point PA4 and the second support point SP1 is greater than the supportable range of each support point. In addition, one of the third distance and the fourth distance corresponding to the reference point PA4 is greater than the distance from each of the other reference points to the first support point SP0 and greater than the distance from each of the other reference points to the second support point SP1. In other words, the reference point PA4 is outside the supportable ranges of first support point SP0 and the second support point SP1, and said one of the third distance and the fourth distance is a maximum distance between the reference point and the support point among all the reference points and all the support points (the first support point SP0 and the second support point SP1). Therefore, the processor 130 selects the reference point PA4 from the reference points PA1 to PA5, PA7, PB1 to PB3, PB6 and PB7 to be the sixth reference point. The processor 130 uses the reference point PA4 as the second support point SP2 and removes the reference point PA4 (as shown by FIG. 4D). In other words, after the reference point PA4 is used as the second support point SP2, the fourth region includes the reference points PA1 to PA3, PA5, PA7, PB1 to PB3, PB6 and PB7.

After the second support point SP2 is determined, the processor 130 executes aforesaid method in an iterative manner so then the reference point PA2 is selected from the reference points PA1 to PA3, PA5, PA7, PB1 to PB3, PB6 and PB7 to be the second support point SP3, and the reference point PA2 is removed. Then, the reference point PB6 is selected to be the second support point SP4 and the reference point PB6 is removed. Next, the reference point PA5 is selected to be the second support point SP5 and the reference point PA6 is removed, as shown by FIG. 4E. When the sixth reference point cannot be selected, the processor 130 stops selecting the sixth reference point. For instance, when the processor 130 determines that positions of remaining reference points are within the supportable ranges (e.g., the supportable ranges R0 to R5 in FIG. 4E) or the remaining reference points no longer exist, the processor 130 stops selecting the sixth reference point. Accordingly, the step of determining the second support point corresponding to the fourth region by selecting the sixth reference point is also ended.

Then, the processor 130 further acquires at least one fifth region by subtracting the second supportable ranges R1 to R5 corresponding to the second support points SP1 to SP5 from the fourth region. With FIG. 4F taken as an example, a plurality of regions not covered by the second supportable ranges R1 to R5 in the fourth region are the fifth regions. The processor 130 determines whether an area (a first area) of each of the fifth regions is greater than a first threshold. When the processor 130 determines that there is the fifth region with the area is greater than the first threshold, the processor 130 creates an additional support point SP6 in the fifth region with the area greater than the first threshold and adds the additional support points SP6 to the second support points. In other words, the fourth region now includes the second support points SP1 to SP6 (FIG. 4F). Subsequently, the processor 130 determines positions (the second positions) of the second support points SP1 to SP6 located in the (N+1)th sliced object L(N+1), adds the positions of the second support points SP1 to SP6 into the (N+1)th slice information LI(N+1) so as to complete step S250.

In certain embodiments, the processor 130 divides an area of the second region surrounded by the second contour pattern C(N+1) by a number of the second support points to obtain a calculation result, and determines whether the calculation result is greater than a threshold (a second threshold) in step S250. When determining that the calculation result is greater than the threshold, the processor 130 creates at least one third support point (not illustrated) in the (N+1)th sliced object L(N+1), and adds the created third support point into the second support points. Accordingly, the created third support point can solve situations of the area of the (N+1)th sliced object L(N+1) being overly large or the number of the second support points being too small, so as to prevent the (N+1)th sliced object L(N+1) from collapsing due to the number of the second support points being insufficient. In certain embodiments, the created third support points are evenly distributed among the fourth region.

Referring back to FIG. 1 and FIG. 2, after the processor 130 completes step S250, the processor 130 controls the print head 120 to print support elements respectively connecting to the first support point and the second support point among the at least one support element on the platform 110 according to the first position of the first support point and the second position of the second support point in step S260.

For example, with FIG. 1, FIG. 2 and FIG. 4F as an example, the processor 130 controls the print head 120 to print support elements respectively connecting to the first support point and the second support point on the platform 110 according to the position of the first support point SP0 and the positions of the second support points SP1 to SP6 in step S260. Accordingly, in the case where the suspended portions of the 3D model are supported by the support elements, the suspended portions of the (N+1)th sliced object L(N+1) can be effectively prevented from collapsing.

In summary, the invention can acquire the first contour pattern and the first support point of the Nth sliced object according to the slice information of the sliced objects of the 3D model, and acquire the second contour pattern and the reference points of the (N+1)th sliced object. According to the first contour pattern, the supportable range of the first support point, the second contour pattern, and the reference points, the invention can determine the second positions of the second support points of the (N+1)th sliced object. Then, the invention can print the support element on the platform according to the first position and the second position. As a result, the suspended portions of the 3D model are supported by the support elements, so as to prevent the suspended portions of the (N+1)th sliced object from collapsing.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A three dimensional printing method for a three dimensional printing apparatus, the three dimensional printing apparatus being configured to print a 3D model and at least one support element supporting the 3D model on a platform, the at least one support element connecting to at least one support point on the 3D model, the three dimensional printing method comprising:
acquiring a plurality of slice information of a plurality of sliced objects corresponding to the 3D model, wherein a normal vector direction of each sliced object among the plurality of sliced objects is identical to a normal vector direction of the platform, the plurality of sliced objects comprise an Nth sliced object and an (N+1)th sliced object adjacent to the Nth sliced object, and a distance between the Nth sliced object and the platform is less than a distance between the (N+1)th sliced object and the platform, wherein N is a positive integer greater than 0;
acquiring a first contour pattern corresponding to the Nth sliced object and a first position of a first support point among the at least one support point located in the Nth sliced object according to first slice information among the plurality of slice information;
acquiring a second contour pattern corresponding to the (N+1)th sliced object according to second slice information among the plurality of slice information;
determining a plurality of reference points located in the second contour pattern;
determining a second position of a second support point among the at least one support point located in the (N+1)th sliced object according to a first region surrounded by the first contour pattern, a first supportable range corresponding to the first support point, a second region surrounded by the second contour pattern and the plurality of reference points; and
printing support elements connecting to the first support point and the second support point respectively among the at least one support element on the platform according to the first position and the second position.

2. The three dimensional printing method according to claim 1, wherein the step of determining the second position of the second support point among the at least one support point located in the (N+1)th sliced object comprises:
acquiring a fourth region by subtracting a third region from the second region, wherein the third region is a region formed by a union of the first region and the first supportable range; and
determining first reference points among the plurality of reference points according to a plurality of end points of the fourth region, wherein each of the first reference points is located on one of the end points of the fourth region.

3. The three dimensional printing method according to claim 2, wherein the step of determining the first reference points among the plurality of reference points according to the plurality of end points of the fourth region comprises:
determining whether a first distance between a second reference point among the first reference points and a third reference point among the first reference points is greater than a first preset distance, wherein the second reference point is adjacent to the third reference point; and
when the first distance is greater than the first preset distance, disposing a fourth reference point between the second reference point and the third reference point such that a distance between the second reference point and the fourth reference point is less than the first preset distance and a distance between the third reference point and the fourth reference point is less than the first preset distance, and adding the fourth reference point into the plurality of reference points.

4. The three dimensional printing method according to claim 3, wherein the step of determining the second position of the second support point among the at least one support point located in the (N+1)th sliced object further comprises:
selecting a fifth reference point from the plurality of reference points, using the fifth reference point as the second support point, and removing the fifth reference point from the plurality of reference points,
wherein a second distance between the fifth reference point and the first support point is greater than a distance from each reference point among the plurality of reference points excluding the fifth reference point to the first support point, and the second distance is greater than a supportable range of each support point among the at least one support point.

5. The three dimensional printing method according to claim 4, wherein the step of determining the second position of the second support point among the at least one support point located in the (N+1)th sliced object further comprises:
selecting a sixth reference point from the plurality of reference points, using the sixth reference point as the second support point, and removing the sixth reference point from the plurality of reference points,
wherein a third distance between the sixth reference point and the first support point is greater than the supportable range of each support point among the at least one support point, and a fourth distance between the sixth reference point and the second support point is greater than the supportable range of each support point among the at least one support point,
one of the third distance and the fourth distance is greater than a distance from each reference point among the plurality of reference points excluding the sixth reference point to the first support point and a distance from each reference point among the plurality of reference points excluding the sixth reference point to the second support point; and
iteratively executing the step of selecting the sixth reference point from the plurality of reference points, using the sixth reference point as the second support point, and removing the sixth reference point from the plurality of reference points until the sixth reference point cannot be selected from the plurality of reference points.

6. The three dimensional printing method according to claim 5, wherein the step of determining the second position of the second support point among the at least one support point located in the (N+1)th sliced object further comprises:
acquiring a fifth region by subtracting a second supportable range corresponding to the second support point from the fourth region;
determining whether a first area of the fifth region is greater than a first threshold; and
when the first area of the fifth region is greater than the first threshold, creating an additional support point in the fifth region and adding the additional support point to the second support point.

7. The three dimensional printing method according to claim 6, wherein the step of determining the second position of the second support point among the at least one support point located in the (N+1)th sliced object further comprises:
dividing a second area of the second region by a number of the second support point to acquire a calculation result;
determining whether the calculation result is greater than a second threshold; and
when the calculation result is greater than the second threshold, creating a third support point in the (N+1)th sliced object and adding the third support point to the second support point.

8. A three dimensional printing apparatus, comprising:
a platform;
a print head, configured to print a 3D model and at least one support element supporting the 3D model on a platform, wherein the at least one support element connecting to at least one support point on the 3D model; and
a processor, configured for:
acquiring a plurality of slice information of a plurality of sliced objects corresponding to the 3D model, wherein a normal vector direction of each sliced object among the plurality of sliced objects is identical to a normal vector direction of the platform, the plurality of sliced objects comprise an Nth sliced object and an (N+1)th sliced object adjacent to the Nth sliced object, and a distance between the Nth sliced object and the platform is less than a distance between the (N+1)th sliced object and the platform, wherein N is a positive integer greater than 0;
acquiring a first contour pattern corresponding to the Nth sliced object and a first position of a first support point among the at least one support point located in the Nth sliced object according to first slice information among the plurality of slice information;
acquiring a second contour pattern corresponding to the (N+1)th sliced object according to second slice information among the plurality of slice information;
determining a plurality of reference points located in the second contour pattern;
determining a second position of a second support point among the at least one support point located in the (N+1)th sliced object according to a first region surrounded by the first contour pattern, a first supportable range corresponding to the first support point, a second region surrounded by the second contour pattern and the plurality of reference points; and
controlling the print head to print support elements connecting to the first support point and the second support point respectively among the at least one support element on the platform according to the first position and the second position.

9. The three dimensional printing apparatus according to claim 8, wherein the processor is further configured for:
acquiring a fourth region by subtracting a third region from the second region, wherein the third region is a region formed by a union of the first region and the first supportable range; and
determining first reference points among the plurality of reference points according to a plurality of end points of the fourth region, wherein each of the first reference points is located on one of the end points of the fourth region.

10. The three dimensional printing apparatus according to claim 9, wherein the processor is further configured for:
determining whether a first distance between a second reference point among the first reference points and a third reference point among the first reference points is greater than a first preset distance, wherein the second reference point is adjacent to the third reference point; and
when the first distance is greater than the first preset distance, disposing a fourth reference point between the second reference point and the third reference point such that a distance between the second reference point and the fourth reference point is less than the first preset distance and a distance between the third reference point and the fourth reference point is less than the first preset distance, and adding the fourth reference point into the plurality of reference points.

11. The three dimensional printing apparatus according to claim 10, wherein the processor is further configured for:
selecting a fifth reference point from the plurality of reference points, using the fifth reference point as the second support point, and removing the fifth reference point from the plurality of reference points,
wherein a second distance between the fifth reference point and the first support point is greater than a distance from each reference point among the plurality of reference points excluding the fifth reference point to the first support point, and the second distance is greater than a supportable range of each support point among the at least one support point.

12. The three dimensional printing apparatus according to claim 11, wherein the processor is further configured for:
selecting a sixth reference point from the plurality of reference points, using the sixth reference point as the second support point, and removing the sixth reference point from the plurality of reference points,
wherein a third distance between the sixth reference point and the first support point is greater than the supportable range of each support point among the at least one support point, and a fourth distance between the sixth reference point and the second support point is greater than the supportable range of each support point among the at least one support point,
wherein one of the third distance and the fourth distance is greater than a distance from each reference point among the plurality of reference points excluding the sixth reference point to the first support point and a distance from each reference point among the plurality of reference points excluding the sixth reference point to the second support point; and
iteratively executing the step of selecting the sixth reference point from the plurality of reference points, using the sixth reference point as the second support points, and removing the sixth reference point from the plurality of reference points until the sixth reference point cannot be selected from the plurality of reference points.

13. The three dimensional printing apparatus according to claim 12, wherein the processor is further configured for:
acquiring a fifth region by subtracting a second supportable range corresponding to the second support point from the fourth region;
determining whether a first area of the fifth region is greater than a first threshold; and
when the first area of the fifth region is greater than the first threshold, creating an additional support point in the fifth region and adding the additional support point to the second support point.

14. The three dimensional printing apparatus according to claim 13, wherein the processor is further configured for:
dividing a second area of the second region by a number of the second support point to acquire a calculation result;
determining whether the calculation result is greater than a second threshold; and
when the calculation result is greater than the second threshold, creating a third support point in the (N+1)th sliced object and adding the third support point to the second support point.
